(19) United States
(12) Patent Application Publication
(10) Pub. No.: US 2025/0173479 A1
(43) Pub. Date: May 29, 2025

(54) ISLAND DETECTION

(71) Applicant: Cricut, Inc., South Jordan, UT (US)

(72) Inventors: Andrew Lewis Cobb, South Jordan, UT (US); Stephen Raymond Otulea Henderson, Hilo, HI (US); Lara Beth Mitchell, San Francisco, CA (US); Matthew Lund Stoker, Bountiful, UT (US)

(73) Assignee: Cricut, Inc., South Jordan, UT (US)

(21) Appl. No.: 18/834,397

(22) PCT Filed: Jan. 31, 2023
(86) PCT No.: PCT/US2023/061634

§ 371 Date: Jul. 30, 2024

Related U.S. Application Data
(63) Continuation of application No. 63/305,160, filed on Jan. 31, 2022.

(51) Int. Cl. G06F 30/20; G06F 113/24; G06F 119/18

(52) U.S. Cl. CPC G06F 30/20; G06F 2113/24; G06F 2119/18

(57) ABSTRACT

A method (800) includes receiving a unique graphical design (202) corresponding to a path (204) to be cut from a material as a stencil (206). Here, the path is represented by one or more contours (205) each including a respective sequence of one or more curves (207) connected to one another. The method also includes executing a path validity classification process (201) to determine whether the path is valid to be cut from the material as the stencil, and, based on the path validity classification process determining the path is not valid to be cut from the material as the stencil, outputting a path invalidity notification (216).

### TECHNICAL FIELD

This disclosure relates to automatic island detection in workpiece material.

### BACKGROUND

When designing graphics for cutting with cutting machines or forming with other manufacturing machines, such as laser cutters or three-dimensional printers, crafters, designers, and/or artists often use multiple graphics or shapes to create a new design or portion of a design to be incorporated on a material by the manufacturing machine. In some examples, using an electronic crafting device (e.g., an electronic cutting machine) to cut shapes and designs into a workpiece may result in “islands” of workpiece material that are liberated from the remaining workpiece, and these liberated “islands” may fall out of engagement with the crafting device and/or may be lost. These liberated pieces of workpiece material may present handling or processing difficulties, especially if the user is unaware that a cutting operation will produce such “islands.”

### SUMMARY

One aspect of the disclosure provides computer-implemented method when executed on data processing hardware causes the data processing hardware to perform operations including receiving a unique graphical design corresponding to a path to be cut from a material as a stencil. The path corresponds to the unique graphical design represented by one or more contours each including a respective sequence of one or more curves connected to one another. The operations also include executing a path validity classification process to determine whether the path corresponding to the unique graphical design is valid to be cut from the material as the stencil. Based on the path validity classification process determining the path corresponding to the unique graphical design presented for display in the virtual canvas window is not valid to be cut from the material as the stencil, the operations further include outputting a path invalidity notification. The path invalidity notification informs a user that the path corresponding to the unique graphical design is not valid to be cut from the material as the stencil.

Implementations of the disclosure may include one or more of the following optional features. In some implementations, determining the path is not valid to be cut from the material as the stencil includes identifying at least one curve in the respective sequence of one or more curves of at least one of the one or more contours representing the path that causes the path validity classification process to determine the path is not valid to be cut from the material as the stencil. In these implementations, the operations may further include executing a design generating program to display on a screen in communication with the data processing hardware a graphical user interface having a virtual canvas window, and presenting the unique graphical design for display in the virtual canvas window. Optionally, outputting the path invalidity notification includes causing the design generating program to output, for display on the screen, the path invalidity notification, and the path invalidity notification displayed on the screen graphically augments the identified at least one curve presented for display in the virtual canvas window. Here, after the design generating program outputs the path invalidity notification for display on the screen, the operations may further include receiving, in the virtual canvas window, manipulation inputs from the user to create a modified path by adjusting one or more of the contours representing the path, the modified path presented for display in the virtual canvas window, and re-executing the path validity classification process to determine if the modified path presented for display in the virtual canvas window is valid to be cut from the material as the stencil. Alternatively, after the design generating program outputs the path invalidity notification for display on the screen, the operations also include modifying, without receiving any modification inputs in the virtual canvas window from the user, the path by adjusting one or more of the contours representing the path so that the modified path is valid to be cut from the material as the stencil.

Additionally or alternatively, after outputting the path invalidity notification, the operations also include generating, using the path corresponding to the unique graphical design that is determined to not be valid to be cut from the material as the stencil, a graphical representation for a virtual stencil cut from the material. Here, the virtual stencil excludes portions of the material defined by any of the one or more contours that caused the path validity classification process to determine the path is not valid to be cut from the material as the stencil. In these implementations, when the stencil includes a negative stencil, the excluded portions of the material include any unsupported shapes of material that are defined by corresponding contours that are not boundary contours. Alternatively, when the stencil includes a positive stencil, each excluded portion of the material includes an unsupported shape of material that is defined by a corresponding contour that is not a single contour defining a boundary of the path, and/or is directly contained by a boundary contour. In these implementations, the operations may further include receiving a user input indication indicating a command to instruct a machine in communication with the data processing hardware to create the stencil from the material by performing a cutting action on the material using the path corresponding to the unique graphical design that is determined to not be valid, the created stencil excluding the same portions of the material excluded by the virtual stencil.

In some examples, executing the path validity classification process to determine whether the path corresponding to the unique graphical design is valid to be cut from the material as the stencil incudes determining whether each of the one or more contours that represent the path corresponding to the unique graphical design define a closed shape. Here, for each corresponding contour of the one or more contours that represent the path corresponding to the unique graphical design, the operations also include determining whether the corresponding contour intersects itself or another one of the one or more contours. Determining that the path corresponding to the unique graphical design is not valid to be cut from the material as the stencil is based on determining that at least one of the one or more contours does not define a closed shape, or intersects itself or another one of the one or more contours. In these examples, when each of the one or more contours that represent the path corresponding to the unique graphical design define the closed shape and each corresponding contour of the one or more contours does not intersect itself or another one of the one or more contours, executing the path validity classification process may further include determining whether each of the one or more contours includes a respective boundary contour, and determining whether the path includes a boundary that is defined by a single contour of the one or more contours representing the path, and for each corresponding contour of the one or more contours that does not include the respective boundary contour, determining whether the corresponding contour is directly contained by another one of the one or more contours that does include the respective boundary contour.

In examples where the stencil includes a negative stencil, determining that the path corresponding to the unique graphical design is not valid to be cut from the material as the stencil may also include determining that the path is not valid to be cut from the material as the negative stencil based on determining that at least one contour of the one or more contours does not include the respective boundary contour. In these examples, the operations may further include determining the path corresponding to the unique graphical design is valid to be cut from the material as a positive stencil based on determining that the path includes the boundary defined by the single contour of the one or more contours, and determining that each of the one or more contours includes the respective boundary contour or is directly contained by another one of the one or more contours that includes the respective boundary contour. In examples where the stencil includes a positive stencil, determining that the path corresponding to the unique graphical design is not valid to be cut from the material as the stencil may further include determining that the path is not valid to be cut from the material as the positive stencil based on determining at least one of the path does not include the boundary defined by the single contour of the one or more contours, or at least one of the one or more contours does not include the respective boundary contour or is not directly contained by another one of the one or more contours that includes the respective boundary contour. In some implementations, determining that the path corresponding to the unique graphical design presented for display in the virtual canvas window is valid to be cut from the material as a negative stencil is based on determining that each of the one or more contours includes the respective boundary contour.

Another aspect of the disclosure provides a system including data processing hardware and memory hardware in communication with the data processing hardware and storing instructions that when executed on the data processing hardware causes the data processing hardware to perform operations including receiving a unique graphical design corresponding to a path to be cut from a material as a stencil. The path corresponds to the unique graphical design represented by one or more contours each including a respective sequence of one or more curves connected to one another. The operations also include executing a path validity classification process to determine whether the path corresponding to the unique graphical design is valid to be cut from the material as the stencil. Based on the path validity classification process determining the path corresponding to the unique graphical design presented for display in the virtual canvas window is not valid to be cut from the material as the stencil, the operations further include outputting a path invalidity notification. The path invalidity notification informs a user that the path corresponding to the unique graphical design is not valid to be cut from the material as the stencil.

This aspect may include one or more of the following optional features. In some implementations, determining the path is not valid to be cut from the material as the stencil includes identifying at least one curve in the respective sequence of one or more curves of at least one of the one or more contours representing the path that causes the path validity classification process to determine the path is not valid to be cut from the material as the stencil. In these implementations, the operations may further include executing a design generating program to display on a screen in communication with the data processing hardware a graphical user interface having a virtual canvas window, and presenting the unique graphical design for display in the virtual canvas window. Optionally, outputting the path invalidity notification includes causing the design generating program to output, for display on the screen, the path invalidity notification, and the path invalidity notification displayed on the screen graphically augments the identified at least one curve presented for display in the virtual canvas window. Here, after the design generating program outputs the path invalidity notification for display on the screen, the operations may further include receiving, in the virtual canvas window, manipulation inputs from the user to create a modified path by adjusting one or more of the contours representing the path, the modified path presented for display in the virtual canvas window, and re-executing the path validity classification process to determine if the modified path presented for display in the virtual canvas window is valid to be cut from the material as the stencil. Alternatively, after the design generating program outputs the path invalidity notification for display on the screen, the operations also include modifying, without receiving any modification inputs in the virtual canvas window from the user, the path by adjusting one or more of the contours representing the path so that the modified path is valid to be cut from the material as the stencil.

Additionally or alternatively, after outputting the path invalidity notification, the operations also include generating, using the path corresponding to the unique graphical design that is determined to not be valid to be cut from the material as the stencil, a graphical representation for a virtual stencil cut from the material. Here, the virtual stencil excludes portions of the material defined by any of the one or more contours that caused the path validity classification process to determine the path is not valid to be cut from the material as the stencil. In these implementations, when the stencil includes a negative stencil, the excluded portions of the material include any unsupported shapes of material that are defined by corresponding contours that are not boundary contours. Alternatively, when the stencil includes a positive stencil, each excluded portion of the material includes an unsupported shape of material that is defined by a corresponding contour that is not a single contour defining a boundary of the path, and/or is directly contained by a boundary contour. In these implementations, the operations may further include receiving a user input indication indicating a command to instruct a machine in communication with the data processing hardware to create the stencil from the material by performing a cutting action on the material using the path corresponding to the unique graphical design that is determined to not be valid, the created stencil excluding the same portions of the material excluded by the virtual stencil.

In some examples, executing the path validity classification process to determine whether the path corresponding to the unique graphical design is valid to be cut from the material as the stencil incudes determining whether each of the one or more contours that represent the path corresponding to the unique graphical design define a closed shape. Here, for each corresponding contour of the one or more contours that represent the path corresponding to the unique graphical design, the operations also include determining whether the corresponding contour intersects itself or another one of the one or more contours. Determining that the path corresponding to the unique graphical design is not valid to be cut from the material as the stencil is based on determining that at least one of the one or more contours does not define a closed shape, or intersects itself or another one of the one or more contours. In these examples, when each of the one or more contours that represent the path corresponding to the unique graphical design define the closed shape and each corresponding contour of the one or more contours does not intersect itself or another one of the one or more contours, executing the path validity classification process may further include determining whether each of the one or more contours includes a respective boundary contour, and determining whether the path includes a boundary that is defined by a single contour of the one or more contours representing the path, and for each corresponding contour of the one or more contours that does not include the respective boundary contour, determining whether the corresponding contour is directly contained by another one of the one or more contours that does include the respective boundary contour.

In examples where the stencil includes a negative stencil, determining that the path corresponding to the unique graphical design is not valid to be cut from the material as the stencil may also include determining that the path is not valid to be cut from the material as the negative stencil based on determining that at least one contour of the one or more contours does not include the respective boundary contour. In these examples, the operations may further include determining the path corresponding to the unique graphical design is valid to be cut from the material as a positive stencil based on determining that the path includes the boundary defined by the single contour of the one or more contours, and determining that each of the one or more contours includes the respective boundary contour or is directly contained by another one of the one or more contours that includes the respective boundary contour. In examples where the stencil includes a positive stencil, determining that the path corresponding to the unique graphical design is not valid to be cut from the material as the stencil may further include determining that the path is not valid to be cut from the material as the positive stencil based on determining at least one of the path does not include the boundary defined by the single contour of the one or more contours, or at least one of the one or more contours does not include the respective boundary contour or is not directly contained by another one of the one or more contours that includes the respective boundary contour. In some implementations, determining that the path corresponding to the unique graphical design presented for display in the virtual canvas window is valid to be cut from the material as a negative stencil is based on determining that each of the one or more contours includes the respective boundary contour.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a graphic preparation environment, in accordance with various implementations;

FIG. 2 is a schematic view of an example graphical user interface having a virtual canvas window for presenting one or more content objects, in accordance with various implementations;

FIGS. 3-5 are schematic views of example content objects, in accordance with various implementations.

FIGS. 6A-6C are schematic views of example graphical user interfaces having content object selection windows for viewing and modifying islands detected in the content for presentation in the virtual canvas window of FIG. 2, in accordance with various implementations;

FIG. 7 is a perspective view of a system including a cutting machine, an exemplary user-assembled multi-substrate workpiece assembly, and a workpiece support material, according to the principles of the present disclosure.

FIG. 8 is a flowchart of an example arrangement of operations for a method of creating a unique design, in accordance with various implementations; and

FIG. 9 is a schematic view of an example computing device that may be used to implement the systems and methods described herein, in accordance with various implementations.

Like reference symbols in the various drawings indicate like elements.

### DETAILED DESCRIPTION

The detailed description of exemplary implementations herein makes reference to the accompanying drawings, which show exemplary implementations by way of illustration. While these exemplary implementations are described in sufficient detail to enable those skilled in the art to practice the disclosure, it should be understood that other implementations may be realized and that logical changes and adaptations in design and construction may be made in accordance with this disclosure and the teachings herein without departing from the spirit and scope of the disclosure. Thus, the detailed description herein is presented for purposes of illustration only and not of limitation.

As used herein, the terms “including,” “comprising,” “having,” and variations thereof mean “including but not limited to” unless expressly specified otherwise. Accordingly, the terms “including,” “comprising,” “having,” and variations thereof are intended to cover a non-exclusive inclusion, such that a process, method, article, or apparatus that comprises a list of elements does not include only those elements but may include other elements not expressly listed or inherent to such process, method, article, or apparatus. An enumerated listing of items does not imply that any or all of the items are mutually exclusive and/or mutually inclusive, unless expressly specified otherwise.

Further, in the detailed description herein, references to “one embodiment,” “an embodiment,” “various implementations,” “one example,” “an example,” “some examples,” “one implementation,” “an implementation,” “some implementations,” etc., indicate that the embodiment, implementation, or example described may include a particular feature, structure, or characteristic, but every embodiment may not necessarily include the particular feature, structure, or characteristic. Moreover, such phrases are not necessarily referring to the same embodiment. Thus, when a particular feature, structure, or characteristic is described in connection with an embodiment or an implementation, it is submitted that it is within the knowledge of one skilled in the art to affect such feature, structure, or characteristic in connection with other implementations whether or not explicitly described. Similarly, the use of the term “implementation” means an implementation having a particular feature, structure, or characteristic described in connection with one or more implementations of the present disclosure. Absent an express correlation to indicate otherwise, an implementation may be associated with one or more implementations. After reading the description, it will be apparent to one skilled in the relevant art(s) how to implement the disclosure in alternative implementations.

Implementations herein are directed toward methods and systems for executing a path validity classification process. The path validity classification process is generally configured to analyze a graphical design (also referred to herein as a ‘path’) to assign classifications to the curves and/or contours of the graphical design, according to various implementations. Based on the determined classifications of the contours that constitute the graphical design, the path validity classification process may be configured to determine whether the graphical design is valid or not valid (invalid) for implementing the graphical design on various materials using various post-design processing procedures. Said differently, the path validity classification process may generally determine if a graphical design is valid or not valid for specific end-uses, and/or may identify which portions (i.e., contours) of a graphical design are causing the graphical design to be not valid for specific end-uses. Accordingly, while many details are included herein pertaining to the path validity classification process determining whether a proposed path is valid or not valid as a stencil, the present disclosure is not limited to the end-use of stencils. Indeed, the methods and systems disclosed herein may be utilized to determine if a proposed graphical design will ‘work’ (i.e., will be valid) to be implemented as various crafting projects (e.g., stickers, etc.).

In at least one aspect of the present disclosure, a path represented by one or more contours may make up a design, where the path validity depends on the classification of the one or more contours, as well as whether the stencil is positive or negative. A user interface may present the design to a user to view before implementing the design on the material. In this way, the user may be informed of any potential invalid contours before the material is cut. For instance, invalid contours may be augmented (e.g., highlighted, different color, bolded, etc.). The ability to visualize a design/graphic is especially advantageous when designing a graphic for cutting on a cutting machine or otherwise forming the graphic on a material with other types of manufacturing machines, such as laser cutters, three-dimensional printers, embossers, milling machine, etc. For instance, it is often vital for the designer to visualize the overall design as it would appear when cut so that the designer can determine whether changes to the design need to be made before cutting, thus saving time and material.

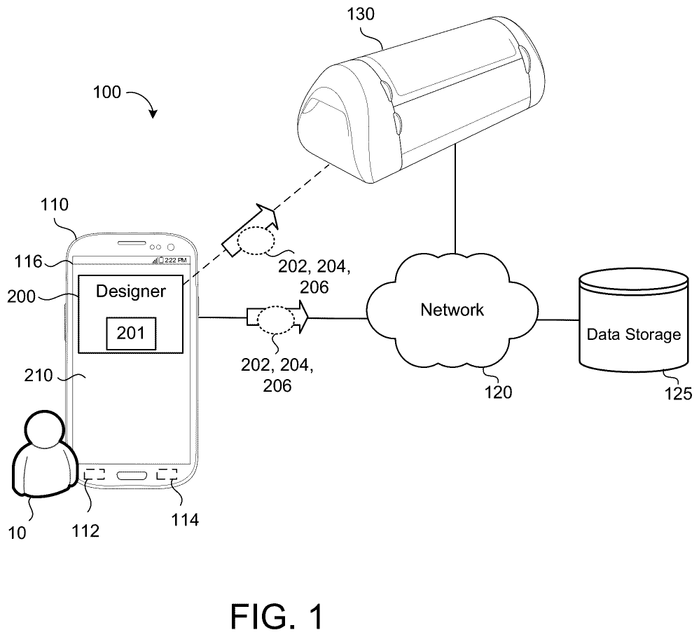

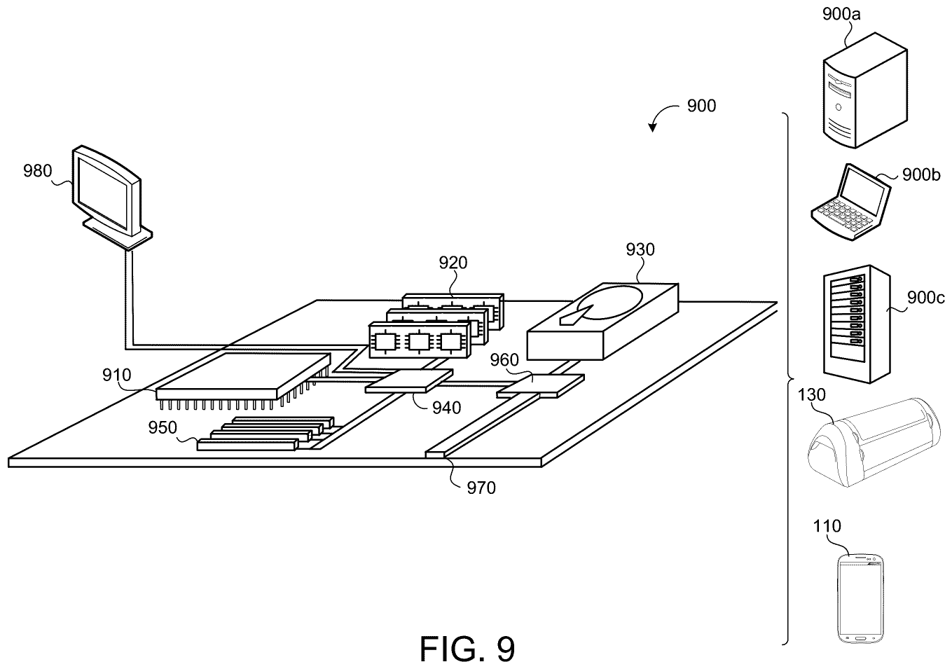

With reference to FIGS. 2-4, FIG. 1 provides a system 100 having an example design preparation environment (also referred to as environment) that includes a user 10 using a user device 110 to create a graphical design 202 (also referred to as a unique design 202, a unique graphical design 202, or a design 202) corresponding to a path 204 to be cut from a material as a stencil 206 during a design process. The path 204 corresponding to the graphical design 202 is represented by one or more contours 205, 205a-n, where each contour 205 includes a respective sequence of curves 207, 207a-n connected to one another. The user device 110 may include data processing hardware 112 and memory hardware 114 in communication with the data processing hardware 112. The memory hardware 114 may store instructions thereon that, when executed on/by the data processing hardware 112, causes the data processing hardware 112 to execute a design generating program 200 (also referred to as designer 200) for creating the graphical design 202 during the design process. As described in greater detail below, the design generating program may be executed by processing/memory hardware of the user device 110 and/or by data processing hardware of a post-design processing machine 130 and/or by remote process/memory hardware (see below with reference to FIG. 9).

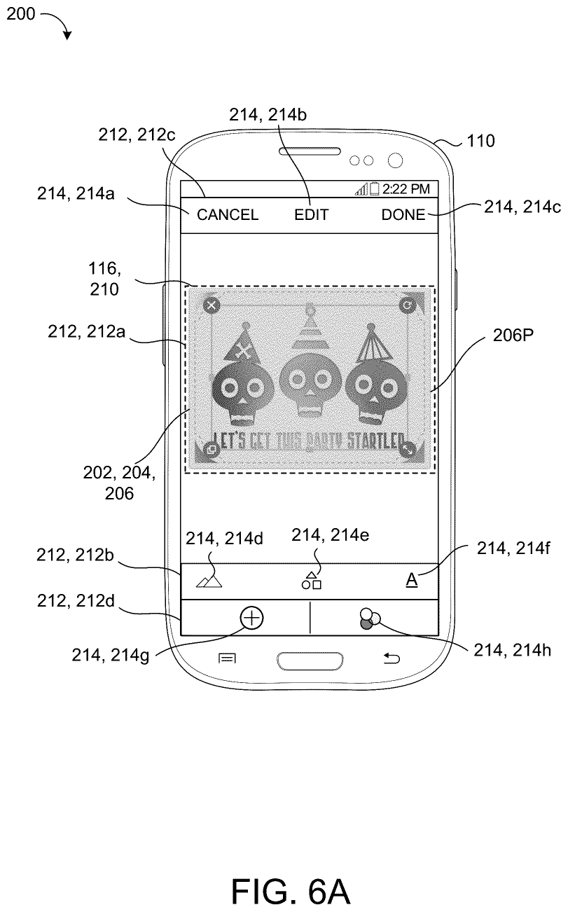

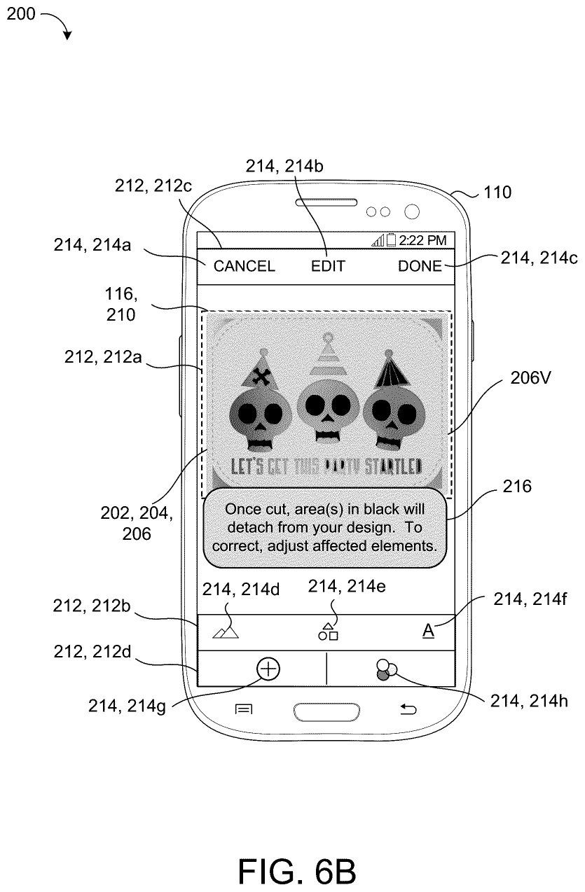

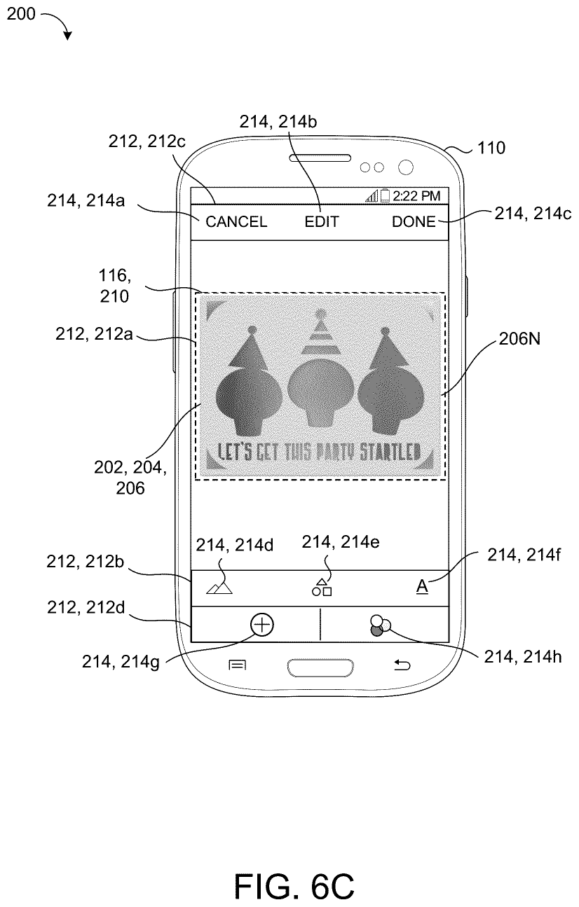

Briefly, and as described in more detail below, once the graphical design 202 from the design process is complete or the user 10 wants to implement the graphical design 202, the design generating program 200 executes a path validity classification process 201 to determine whether the path 204 corresponding to the unique graphical design 202 is valid to be cut from the material as the stencil 206. If the path validity classification process 201 determines that the path 204 is not valid to be cut from the material as the stencil 206, the design generating program 200 outputs a path invalidity notification 216 (FIG. 6B) informing the user 10 that the path 204 corresponding to the unique graphical design 202 is not valid to be cut from the material as the stencil 206, according to various implementations. Conversely, if the path validity classification process 201 determines that the path 204 is valid to be cut from the material as the stencil 206, the designer 200 may communicate the design 202 to the post-design processing machine 130 for post-design processing operations that may include a printing and/or a converting process (e.g., forming, cutting, printing, etc.) to implement the design on a material. That is, the post-design processing operation(s) may convert the graphical design 202 into a physical product or other tangible medium.

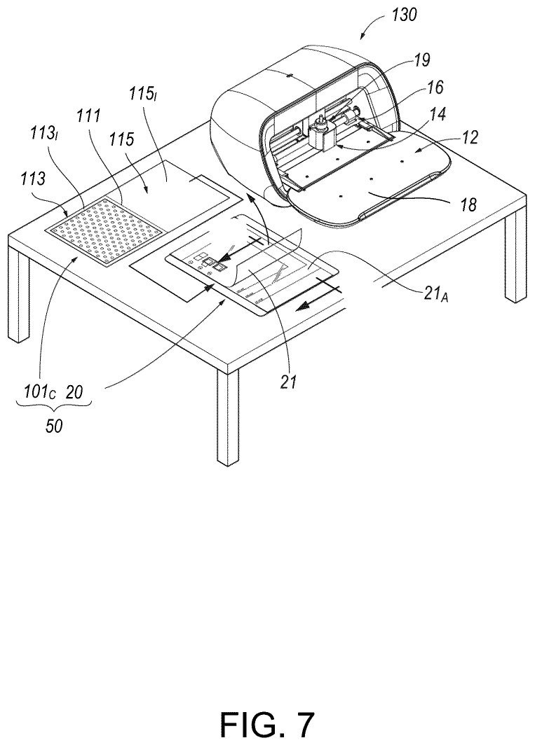

For instance, in the example shown in FIG. 1, the designer 200 communicates the graphical design 202 (i.e., the path 204 to be cut as the stencil 206) to a post-design processing machine 130 configured to implement the received graphical design 202 on a material. The designer 200 may communicate the design 202 to the machine 130 via an indirect connection (e.g., a network 120) or a direct connection (e.g., using a wired or wireless connection as shown by the dotted line of FIG. 1). In the example shown, the post-design processing machine 130 includes a cutting machine configured to cut the unique design 202 from a cutting material. The post-design processing machine 130 may be capable of performing, without limitation, one or more of the following actions on a material: electronic cutting; laser cutting; cutting; milling; embossing; stitching; heat-pressing; printing; drawing; or three-dimensional printing. As described below with respect to FIG. 7, the post-design processing machine 130 may be capable of performing the aforementioned actions on a multi-layer material including one or more substrate layers folded upon themselves.

The user device 110 may correspond to any computing device associated with the user 10 and capable of executing the design generating program 200 (i.e., the designer 200) to generate the unique design 202. Some examples of user devices 110 include, but are not limited to, mobile phones, tablets, laptops, desktop computers, etc. In some examples, the design generating program 200 executes on the post-design processing machine 130. Here, the designer 200 may refer to a software application hosted on the user device 110 or some portion of a software application hosted on the user device 110. For instance, the designer 200 may include a module within larger graphics editor software. Additionally or alternatively, the designer 200 may be a proprietary application or a portion of a proprietary application. For instance, the designer 200 may include a proprietary application specific to the post-design processing machine 130. In some implementations, the designer 200 runs on the post-design processing machine 130.

The designer 200 may be generally configured to execute the path validity classification process 201 in addition to performing design functions, such as layout, editing, formatting, importing/exporting features (e.g., images, shapes, text, etc.), etc. In some implementations, the designer 200 is configured to display on a screen/display 116 in communication with the data processing hardware 112 that includes a graphical user interface 210 that enables the user 10 to interact with the designer 200 to perform design functions. Here, the user 10 may interact with the graphical user interface 210 on the screen 116 of the device 110 as the data processing hardware 112 of the device 110 executes the designer 200.

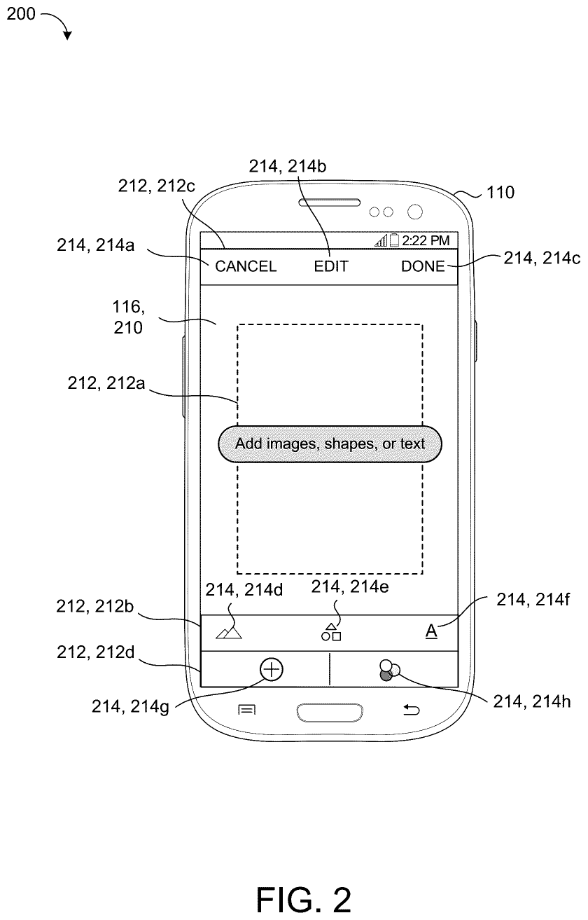

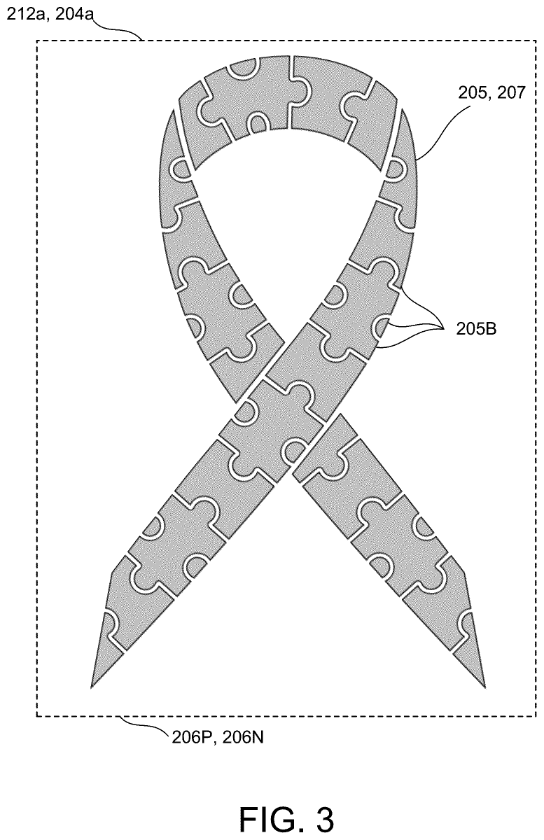

Referring to FIG. 2, the graphical user interface 210 has windows 212, 212a-d including a virtual canvas window 212a (FIGS. 3-6B) that the user 10 may interact with via touch, stylus, mouse/cursor, gesture, and/or speech. The virtual canvas window 212a may be configured to present one or more selected contours 205 to be incorporated into the unique design 202. As will become apparent, the virtual canvas window 212a virtually represents a sheet of material to provide a virtual canvas to layout and/or build the unique design 202 to be formed from the sheet of material, according to various implementations. One or more of the windows 212 may contain selectable icons 214, 214a-k that the user 10 may select to facilitate the creation or the modification of a design 202. Each icon 214 may correspond to a particular function depending on the window 212 where the particular icon 214 is located in the graphical user interface 210. The graphical user interface 210 may also have a content type selection window 212b including one or more icons 214d-f each associated with a respective content object type. For instance, photo icon 214d is associated with a content object type corresponding to photos, shape icon 214e is associated with a content object type corresponding to shapes, and text icon 214f is associated with a content object type corresponding to textual characters (e.g., letters, numbers, and/or symbols).

FIG. 2 also shows the graphical user interface 210 having additional windows 212c, 212d that allow the user 10 to add or to modify/manipulate content (e.g., contours 205 and/or curves 207 of the path 204) displayed in the virtual canvas window 212a or to perform various commands related to the design generating program (i.e., the designer) 200. For instance, the graphical user interface 210 may include a command window 212c providing various commands that govern functions of the designer, such as an accept command to ensure that a user 10 wants to perform a particular action or function selected. Here, the user 10 may select a “done” icon 214c in the command window 212c to provide the accept command. The command window 212c may further include cancel and edit icons 214a, 214b that permit the user to cancel a particular selection and edit a graphical design 202. By having command icons 214, the user interface 210 may navigate between windows 212 or know when functionality related to a particular window 212 is complete (e.g., to return the user 10 to the canvas window 212a).

In some examples, the user 10 interacts with the graphical user interface to combine multiple contours 205 into a single unique design 202 for cutting on the cutting machine 130. For example, the designer 200 may allow the user 10 to have a real-time view presenting the design 202 on the graphical user interface 210 as the designer 200 creates the design 202 from a multitude of different contours 205. The graphical user interface 210 may include a content object selection window (not shown) that may include available contours 205, where each contour 205 includes a respective sequence of curves 207 connected to one another for selective presentation in the virtual canvas window 212a. Additionally or alternatively, the user 10 may opt to draw contours 205 for presentation in the virtual canvas window 212a. As used herein, contours 205 may be composed of multiple curves 207 that are connected start-to-end, sharing an anchor point. Contours 205 may be shapes or free-form curves 207, which are designated as either closed (i.e., shapes) or open (i.e., free-form curves 207), and may define a single shape, a curve, or a sequence of curves that intersect. Curves 207 may include an order of three (3) (i.e., a cubic curve), two (2) (i.e., a quadratic curve), or one (1) (i.e., a linear curve or a line segment), and include two (2) anchor points that form a start and end point, and one or more inflections, loops, and/or cusps.

As described above, a path 204 corresponding to the graphical design 202 is represented by one or more contours 205, each contour 205 including a respective sequence of curves 207 connected to one another. The path validity classification process 201 may identify one or more classifications that the paths 204 fulfill to identify the presence of islands 208 (i.e., unsupported shapes of material) that may be cut out of the material by the cutting machine 130, resulting in a path 204 that is not valid. For example, paths 204 may be classified by, without limitation, “boundary contour,” “single contour boundary,” “intersecting,” “intersecting free,” and/or “boundary contained.” In these examples, “boundary contour” may refer to a path 204 that includes contours 205 that form the outer boundary of the path 204 and/or are the entire path 204 of the stencil 206. Put another way, a contour 205 does not constitute a boundary contour if the contour 205 is contained within another contour 205. A “single contour boundary” may include a path 204 defined by a single boundary contour 205B. A path 204 that includes contours 205 that do not intersect themselves or other contours 205 in the path 204 may be generally classified as “intersecting free” while a path 204 that includes one or more contours 205 that intersect themselves or one or more other contours 205 in the path 204 may be classified as “intersecting.” A “boundary contained” path refers to a path 204 including one or more contours 205 contained within an outer boundary contour 205B that forms the outer boundary of the path 204.

Additionally, the user 10 may designate whether the unique design 202 includes a positive stencil 206P or a negative stencil 206N. Here, a positive stencil 206P refers to an amount of material (e.g., an area corresponding to a contour 205) that will remain or still be present after the post-processing operation (e.g., the cutting of the cutting machine 130). Designs 202 in a positive stencil 206P may be used to implement the designs in materials in which the remaining portion of the material (i.e., the positive shape) is the end-goal of the design (e.g., the material to be implemented as stickers and/or to be applied onto other objects and/or transferred to other objects)h. Conversely, a negative stencil 206N refers to an amount of material (e.g., one or more areas corresponding to a contour 205) that will be “cut-out” during/after the post-processing operation, thereby resulting in negative space that is removed from the surrounding material by the cutting machine 130. Designs 202 in a negative stencil 206N may be used to create conventional stencils and/or in card making applications where holes are cut in the card to represent the graphic or text on the card (e.g., with an underlying insert or layer being visible through the designed cut-out).

After the graphical design 202 from the design process is complete, or once the user 10 has selected and/or identified the graphical design 202 he/she wants to implement, the design generating program 200 executes the path validity classification process 201 to determine whether the path 204 corresponding to the unique graphical design 202 is valid to be cut from the material as the stencil 206, according to various implementations. The path validity classification process 201 generally analyzes the one or more contours 205 that represent the path 204 corresponding to the unique design 202 to assign classifications to the one or more contours 205. For example, the path validity classification process 201 may determine whether each of the one or more contours 205 define a closed shape, and, for each corresponding contour 205 that represents the path 204 corresponding to the unique design 202, determines whether the corresponding contour 205 intersects with itself or another one of the one or more contours 205. In other words, the path validity classification process 201 determines whether any of the contours 205 in the path 204 cross any of the other contours 205 in the path 204, or cross over itself, and/or form a closed shape, according to various implementations. For example, when the path validity classification process 201 determines that at least one of the one of the one or more contours 205 does not define a closed shape or intersects itself or another one of the one or more contours 205, the path validity classification process 201 may determine that the path 204 corresponding to the unique design 202 is not valid to be cut from material as the stencil 206.

The path validity classification process 201 may further include, in response to each of the one or more contours 205 that represent the path 204 corresponding to the unique design 202 being classified as a closed shape and each corresponding contour 205 of the one or more contours 205 being classified as “intersection free” (i.e., not intersecting itself or another one of the one or more contours 205), determining whether each of the one or more contours 205 includes a respective boundary contour 205B, and determining whether the path 204 includes a boundary that is defined by a single contour 205 of the one or more contours 205 representing the path 204, according to various implementations. Here, for each corresponding contour 205 that does not include a respective boundary contour 205B, the path validity classification process 201 may determine whether the corresponding contour 205 is directly contained by another one of the one or more contours 205 that do not include the respective boundary contour 205B. Put another way, the path validity classification process 201 may determine whether the particular contour 205 is contained by another contour 205 that does not constitute a boundary contour 205B.

Continuing with the example, where the user 10 has designated the stencil 206 of the unique design 202 as a negative stencil 206N, the path validity classification process 201 may determine that the path 204 corresponding to the unique graphical design 202 is not valid to be cut from the material as the negative stencil 206N by determining that at least one contour 205 of the one or more contours 205 does not include the respective boundary contour. When the path validity classification process 201 determines that the path 204 is not valid to be cut from the material as the negative stencil 206N, the path validity classification process 201 may further identify whether the path 204 is valid to be cut from the material as a positive stencil 206P. For example, the path validity classification process 201 may determine that the path 204 includes a boundary defined by a single contour 205 of the one or more contours 205 and that each of the one or more contours 205 includes the respective boundary or is directly contained by another one of the one or more contours 205 that include the respective boundary contour 205B. Based on this, the path validity classification process 201 may determine that the path 204 is valid to be cut from the material as a positive stencil 206P.

Conversely, where the user 10 has designated the stencil 206 of the unique design 202 as a positive stencil 206P, the path validity classification process 201 determines whether the path 204 corresponding to the unique graphical design 202 is valid based on whether the path 204 does not include the boundary defined by a single contour of the one or more contours 205 or whether at least one of the one or more contours 205 do not include the respective boundary contour 205B or is not directly contained by another one of the one or more contours 205 that include the respective boundary contour 205B. Based on the path validity classification process 201 determining either of these conditions exist in the design 202, the path validity classification process 201 determines that the path 204 is not valid to be cut from the material as the positive stencil 206P. When the path validity classification process 201 determines that the path 204 is not valid to be cut from the material as the positive stencil 206P, the path validity classification process 201 may further identify whether the path 204 is valid to be cut from the material as a negative stencil 206N. For example, the path validity classification process 201 may determine that each of the one or more contours 205 include a respective boundary contour 205B, and therefore form a path 204 that is valid to be cut as a negative stencil 206N.

Other implementations include the user creating a unique graphical design 202 without designating the stencil 206 as a positive stencil 206P or a negative stencil 206N. As such, the path validity classification process 201 determines whether the unique graphical design 202 is valid as the positive stencil 206P as well as whether the unique graphical design 202 is valid as the negative stencil 206N. Some designs 202 may be valid as both positive and negative stencils 206P, 206N as long as the necessary conditions are satisfied. In various implementations, the design generating program 200 may enable the user to select, via the graphical user interface 210, whether the user intends to implement the design as a positive stencil or a negative stencil. The path validity classification process 201 may receive this user input to influence the determination of path validity (e.g., some paths may be valid as positive stencils but invalid as negative stencils), as described in greater detail below. In various implementations, aspects of the present disclosure may be utilized and implemented for analyzing an image/design library and tagging and/or identifying which images/designs are valid as a positive stencil, as a negative stencil, or as both. Said differently, the methods, programs, and processes disclosed herein may be implemented by processing hardware and processing memory to determine which images/designs will work for specific types of materials and/or specific types of post-design material processing (e.g., cutting).

In various implementations, if a design is intended to be implemented in a material having backing layer (also known as a carrier layer) that is not intended to be cut through during the processing, stencil validity processing and associated determinations may not be necessary as the uncut backing layer may retain the cutout portions of the design that would otherwise have been liberated if not for the backing layer retaining the “islands” in place relative to the remaining portions of the design. Similarly, if the planned post-design material processing (e.g., cutting) involves the use of an adhesive mat or other material retention arrangement to secure the material in place, stencil validity processing may not be necessary, as the adhesive mat may retain the cutout portions of the design that would otherwise have been liberated if not for the adhesive mat retaining the “islands” in place relative to the remaining portions of the design. Said differently, the design generating program 200 may be configured to determine (via user input or otherwise) if the material to be processed has a backing layer and/or if the planned post-design material processing includes using an adhesive mat to support and retain the material, as these factors, may warrant whether validity classification processing is needed. Thus, the contemplated method and processes for determining the validity of the design to be used as a stencil may be triggered in response to the user selecting a type of material on which to implement the design and/or in response to the user selecting a type of post-design material processing, according to various embodiments.

The following examples provided below with reference to FIGS. 3-5B are described in the context of needing validity classification processing, and thus the functionality described below with reference to FIGS. 3-5B may be for materials that do not have a backing layer and/or for processing that does not involve an adhesive mat, according to various implementations. In various implementations, the validity classification processing involves determining which contours of a proposed path contain other contours. Said differently, the path validity classification process may be configured to determine which contours are bounded by other contours, and thus the path validity classification process may generate and assign a hierarchy to the contours that constitute a graphical design. The program may thus be configured to utilize this generated contour hierarchy to determine, based on a selected post-design processing and a selected material to receive the graphical design, if a specific graphical design is able to be implemented in/on the selected material using the selected post-design processing.

Referring to FIGS. 3-5B, the virtual canvas window 212a includes one or more contours 205 that form paths 204, 204a-d to be cut from material as a stencil 206. As will become clear, contours 205 shown in a solid line may correspond to a boundary contour 205B that will generally form a valid path 204 to be cut from the material, while contours 205 shown in a dashed line may correspond to single contours 205 that are contained within a boundary contour 205B and accordingly may form a path 204 that is not valid to be cut from the material based on whether the stencil 206 is a negative stencil 206N or a positive stencil 206P. The depicted examples are merely illustrative representations of the functionality of the designer 200, whereby rudimentary shapes are provided by example only to illustrate an example design process. As such, the designer 200 can be expanded beyond the examples disclosed herein to enable the designing of an unlimited number of designs 202 including any combination of any shape, color, photo, character/text, custom designs, or any type of graphic generally enabled by conventional design software.

As shown in FIG. 3, a path 204a is shown in the virtual canvas window 212a and includes a plurality of contours 205 each formed by one or more curves 207 to generate complimentary puzzle piece shapes that collectively form a ribbon shape. Notably, because each of the contours 205 shown are not enclosed within a different boundary, the path validity classification process 201 may determine that path 204a includes one or more single contours 205 that each form a respective boundary contour 205B, and that the path 204a does not include any boundary contained contours 205. Additionally, the path validity classification process 201 determines that the path 204a does not include any contours 205 that intersect with themselves or any other of the contours 205 shown. Based on the classifications determined by the path validity classification process 201, the path 204a may or may not be valid to be cut from material as a positive stencil 206P or a negative stencil 206N. Specifically, because the contours 205 in the path 204a each form their own boundary contour 205B (i.e., none of the contours 205 are contained by another contour 205), and because the path 204a is intersection free, the path validity classification process 201 determines that the path 204a is valid to be cut from material as a negative stencil 206N. Conversely, because the path 204a is intersection free, any shapes formed by the contours 205 are disconnected and will fall away from each other (i.e., separate) when cut by the machine 130. Accordingly, the path 204a shown in FIG. 3 is not valid to be cut from the material as a positive stencil 206P.

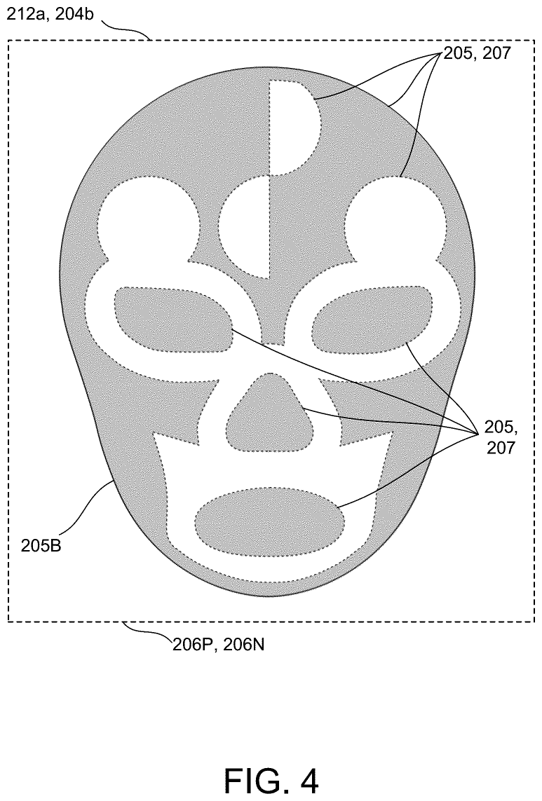

Referring now to FIG. 4, a path 204b is shown in the virtual canvas window 212a and includes a plurality of contours 205 each formed by one or more curves 207 to generate a mask with cutouts for a mouth, nose, eyes, and a forehead. Here, the path 204b includes a single boundary contour 205B that forms the outline of the mask. Within the boundary contour 205B are additional single contours 205 that are either directly contained by the boundary contour 205B, or are contours 205 contained within another contour 205 that is contained by the boundary contour 205B. These latter contours 205 may generally form islands that, by virtue of their location within a non-boundary contour 205, will be cut from the material. Additionally, the path 204b includes a contour 205 that intersects itself (i.e., the forehead contour 205); however the path 204b does not include any contours 205 that intersect other contours 205 within the path 204b. Based on the classifications determined by the path validity classification process 201, the path 204b may or may not be valid to be cut from material as a positive stencil 206P or a negative stencil 206N. Particularly, when the stencil 206 is a positive stencil 206P, all of the contours 205 contained within the boundary contour 205B that are disconnected will fall away from each other (i.e. separate) when cut by the machine 130. Accordingly, the path 204b shown in FIG. 4 is not valid to be cut from the material as a positive stencil 206P, as any material defined by the contours within the boundary contour 205B will be cut from the material in a positive stencil 206P. In the example, the shaded regions defining the eyes, nose, and mouth would for islands that would be cut from the material. Conversely, when the stencil 206 is a negative stencil 206N, any contours 205 that are directly contained within the boundary contour 205B will be determined as invalid by the path validity classification process 201. That is, any contours 205 that are contained within the boundary contour 205B and do not intersect with any of the other boundaries 205 will form an island that will be cut from the material as the negative stencil 206N.

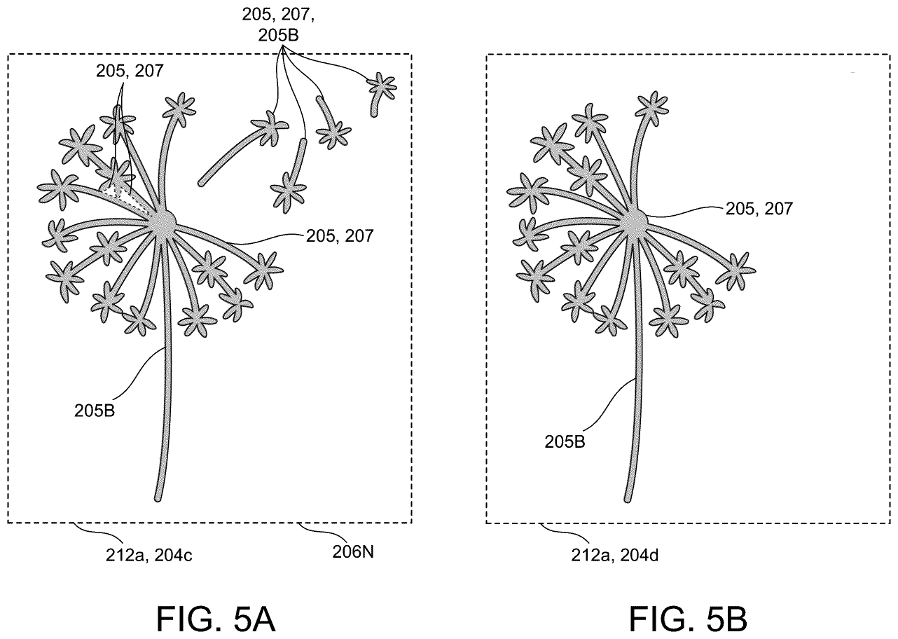

Referring to FIG. 5A, path 204c is shown in the virtual canvas window 212a and includes a plurality of contours 205 that are each formed by one or more curves 207 to generate a flower with petals that are floating away from the flower. Here, the path validity classification process 201 determines that the path 204c includes a boundary contour 205B that forms the outline of the flower, as well as boundary contours 205B that form the separate petals. As shown, the contours 205 of adjacent petals still attached to the flower connect to form a boundary contained within the boundary contour 205B that also intersects with the boundary contour 205B. Moreover, while the floating petals are formed by respective individual boundary contours 205B, none of the petals include contours that intersect with other contours 205. If the path 204c defines a negative stencil 206N where the shaded regions define the shape of the flower with petals to be cut from the material, the path validity classification process 201 would determine that the path 204c is invalid as the negative stencil 206N since the contours (depicted by dashed lines) 205 are contained a boundary contour 205B. In other words, the contours (depicted by the dashed lines) that are intended to be material would be cut from the material when cut by the machine 130 since they are contained by a boundary contour 208B. Notably, these same contours (depicted by the dashed lines) would not be deemed invalid if the path 204c instead defined a positive stencil 206P where the white regions are cut from the material and the shaded region is material. However, because the additional boundary contours 205B that form the floating petals are not connected/do not intersect with any other contours 205, the path validity classification process 201 would also determine that the path 204c is not valid to be cut from material as the positive stencil 206P.

Referring to FIG. 5B, path 204d is shown in the virtual canvas window 212a, and is substantially similar to the path 204c, however the design 202 has been modified by adjusting one or more contours 205 so that the path 204d is valid to be cut from material as both a negative stencil 206N and a positive stencil 206P. Specifically, the contours 205 that formed the adjacent petals previously represented by the dashed line contours contained by the boundary contour 205B have been adjusted to separate from the boundary contour 205B, thereby eliminating the contours 205 formed within the boundary contour 205B. As such, the path validity classification process 201 would determine that the path 204d of FIG. 5B is valid as the negative stencil 206N. While omitted from FIG. 5B, the floating petals of FIG. 5A would still be deemed valid as the negative stencil 206N. Yet, to also be deemed valid as the positive stencil 206P, the contours 205 that formed the floating petals have been removed. Accordingly, the path validity classification process 201 may determine that the path 204d is valid as both a positive stencil 206P and as a negative stencil 206N.

In the example of FIG. 5B, the design generating program 200 may adjust the path 204d so that it is valid as either one of or both of the negative stencil 206N and the positive stencil 206P. For instance, after the path validity classification 201 determines the path 204c of FIG. 5A is invalid, the design generating program 200 may prompt the user to confirm that the user would like the design generating program 200 to form the valid path 204d by adjusting the contours 205 that rendered the path 204c invalid. The design generating program 200 could form one path 204d that is valid as a positive stencil 206P (and not as a negative stencil 206N) and form another path 204d that is valid as the negative stencil 206N (and not the positive stencil 206P). The user could then select which path (positive or negative stencil) the user wants to be cut from the material. In other implementations, the user may manually adjust the contours 205 that rendered the path 204c of FIG. 5A invalid to form the path 204d. Here, the path validity classification 201 may graphically augment the contours deemed invalid (e.g., the dashed line contours deemed invalid as the negative stencil, or the floating flower petals deemed invalid as the positive stencil) so that the user can identify which contours need to be adjusted so that the necessary conditions are satisfied by the path validity classification process 201. Notably, the user 10 may acquiesce to an invalid path 204 and opt to have the path 204 design to be cut from the material anyway, where the user accepts to lose the island regions.

Referring now to FIGS. 6A-6B, the virtual canvas window 212a of the design generating program 200 is shown including one or more contours 205 that the user 10 selected for the design 202. In the example shown in FIG. 6A, the path 204 of the design includes multiple contours 205 contained within both boundary contours 205B as well as contours 205 contained within contours 205 that are not boundary contours 205B. Here, the path validity classification process 201 determines whether the path 204 is not valid to be cut from the material as the stencil 206 by identifying at least one curve 207 in the respective sequence of one or more curves 207 of at least one of the one or more contours 205 is not valid to be cut from the material as the stencil 206. In other words, the path validity classification process 201 identifies any curves 207 in the path 204 that would cause material to be cut from the stencil 206 that is not intended by the user 10.

As shown in FIG. 6B, based on the path validity classification process 201, the design generating program 200 outputs, for display on the screen 116, a path invalidity notification 216 displayed on the screen 116 informing the user 10 that the submitted path 204 corresponding to the unique graphical design 202 is not valid to be cut from the material. Here, the path invalidity notification 216 may include a note to the user “Once cut, area(s) in black will detach from your design. To correct, adjust affected elements.” In addition to the path invalidity notification 216, the designer 200 may generate, using the path 204 corresponding to the unique graphical design 202 that is determined to not be valid to be cut from the material as the stencil 206, a graphical representation for a virtual stencil 206V cut from the material. Here, the virtual stencil 206V excludes portions of the material defined by any of the one or more contours 205 that caused the path validity classification process 201 to determine the path 204 is not valid to be cut from the material as the stencil 206. For example, the designer 200 may generate drop shadows on the one or more contours 205 that caused the path validity classification process 201 to determine the path 204 is not valid to illustratively convey to the user 10 what is going to happen during post-design processing (e.g., cutting on the cutting machine 130).

As shown in FIGS. 6A and 6B, when the stencil 206 is a negative stencil 206N, the excluded portions of the material include any unsupported shapes of the material that are defined by corresponding contours 205 that are not boundary contours 205B. Specifically, any contours 205 within the negative stencil 206N that are contained by boundary contours 205B will not be supported by the design 202 remaining after the material is cut, and therefore are not valid. These contours would include the contours forming the eyes, noses, and mouths of the skeleton heads. In implementations where the stencil 206 shown in FIG. 6A is a positive stencil 206P, any contours 205 that are not a single contour 205 defining a boundary contour 205B of the path 204, or contour 205 that are not directly contained by the boundary contour 205B are considered unsupported shapes of the material that will be excluded from the remaining design 202 after the material is cut, and therefore are not valid, i.e., each skeleton head, the individual letters, and features of the hats.

In some implementations, after the design generating program 200 outputs the path invalidity notification 216 for display on the screen 116, the design generating program 200 modifies, without receiving any modification inputs in the virtual canvas window 212a from the user 10, the path 204 by adjusting one or more of the contours 205 representing the path 204 so that the modified path 204 is valid to be cut from the material as the stencil 206. In these implementations, the design generating program 200 may generate a graphical element representing a button for the user 10 to select, the selection of the button causing the design generating program 200 to modify the path 204 so that the modified path 204 is valid to be cut from the material. Alternatively, the design generating program 200 may automatically modify the path 204 so that the modified path 204 is valid to be cut from the material as the stencil 206 and display, in the virtual canvas window 212a, the modified path 204 for the user 10 to approve, deny, and/or further modify. In some examples, the design generating program 200 automatically re-executes the path validity classification process 201 to generate a modified path 204 that is valid to be cut from the material as the stencil 206.

In other implementations, after the design generating program 200 outputs the path invalidity notification 216 for display on the screen 116, the design generating program 200 receives, in the virtual canvas window 212a, manipulation inputs from the user 10 to create a modified path 204 by adjusting one or more of the contours 205 representing the path 204. Here, in response to receiving the user manipulation inputs, the design generating program 200 re-executes the path validity classification process 201 to determine whether the modified path 204 presented for display in the virtual canvas window 212a is valid to be cut from the material as the stencil 206.

Referring now to FIG. 6C, in some implementations, the design generating program 200 is configured to provide a preview of what the design may look like if invalid boundaries are not resolved. Said differently, the path invalidity notification may take the form of a graphical image displayed on the screen indicating to the user what the design may look like if the invalid contours are not resolved. That is, the design generating program 200 may be configured to show a preview of how the final design would appear if the post-design processing were to be performed and the “island” portions were liberated (i.e., fell away from the remaining portions). Similarly, and according to various implementations, the design generating program 200 may receive a user input indication indicating a command to instruct the machine 130 in communication with the data processing hardware 112 of the user device 110 to create the stencil 206 from the material by performing a cutting action on the material using the path 204 corresponding to the unique graphical design 202 that is determined to not be valid. In other words, the user 10 may elect to disregard the identified portions of material that are unsupported by the invalid path 204 and command the stencil 206 be created excluding the same portions of the material excluded by the virtual stencil 206V. Here, the user 10 commands the machine 130 to create a negative stencil 206N that excludes the contours 205 in the design 202 that are not a boundary contour 205B.

Referring to FIG. 7, the designer 200 may communicate the completed/approved design 202 to a cutting machine 130 that may cut the stencil 206 from material inserted into the cutting machine 130 by the user 10. The material may include a single sheet of material, or a multi-substrate workpiece assembly 101c may be used. As seen in FIG. 7, the cutting machine 130 includes a tool 19 interfaced with a carriage 14 of the cutting machine 130, and a door 12 that is configured for arrangement in an open orientation in order to allow a workpiece 50 (e.g., a material), which may include, collectively, a workpiece support material 20 and a user-assembled multi-substrate workpiece assembly 101c, to be inserted into the cutting machine 130. The door 12 may be selectively opened and closed via a hinge mechanism (not shown) where the door 12 connects to the cutting machine 130. The cutting machine 130 may also include various internal components, such as, for example, a roller assembly 16. The tool 19 may be configured to only be plunged (according to a direction in the Z direction with respect to the X-Y-Z Cartesian coordinate system) at a distance less than or equal to the combined thickness of various substrates 102, 104′ within the substrate workpiece assembly 101c. Accordingly, in some implementations, the tool 19 does not contact, penetrate, or otherwise disrupt a thickness of a second substrate layer 106 of the substrate workpiece assembly 101c.

The cutting machine 130 also defines a working surface 18, a portion of which may define an upwardly-facing surface of the door 12 when the door 12 is arranged in an open configuration. The working surface 18 may provide a surface on which one or both of the user-assembled multi-substrate workpiece assembly 101c and the workpiece support material 20 (and/or other implements, such as, for example, other cutting mats) can rest when fed forward and/or backward through the cutting machine 130 by the roller assembly 16. As, for example, one or both of the user-assembled multi-substrate workpiece assembly 101c and the workpiece support material 20 is fed forward-and-backward by the roller assembly 16, the carriage 14, which manipulates the tool 19 upwardly-and-downwardly relative to the working surface 18, can move back-and-forth laterally across one or both of the user-assembled multi-substrate workpiece assembly 101c and the workpiece support material 20 (and/or other implements, such as, for example, other cutting mats) in order to conduct work on or alter the user-assembled multi-substrate workpiece assembly 101c.

One or both of the user-assembled multi-substrate workpiece assembly 101c and the workpiece support material 20 that is/are fed into the cutting machine 130 may be worked upon or altered in a number of ways based on the design 202 submitted by the user 10, depending on, for example, the type of the tool 19 that may be removably-interfaced with the carriage 14. For example, in some configurations, the tool 19 may include a cutting blade, a scoring tool, an ink pen/marker, or other tools that may be associated with creating arts-and-crafts projects. The workpiece support material 20 disclosed herein is configured to be fed into the cutting machine 130, as well as other home-use electronic cutting machines. In addition, workpiece support material 20 of the present disclosure may be configured to be used without a cutting machine 130, where a user can alter the material by hand using handheld cutting blades, pens/markers, scoring tools, or other handheld crafting tools.

As shown, the user-assembled multi-substrate workpiece assembly 101c may be alternatively referred to as a card (e.g., a sheet of material that is folded upon itself at the living hinge 111 that results in the user-assembled multi-substrate workpiece assembly 101c including: (1) a front cover panel 113 defining an outer surface 113ₒ and an inner surface 113_{I}; and (2) a rear cover panel 115 defining an outer surface 115ₒ and an inner surface 115_{I}. Accordingly, one or both of the inner surface 113_{I} of the front cover panel 113 and the inner surface 115_{I} of the rear cover panel 115 of the user-assembled multi-substrate workpiece assembly 101c may include the design 202 having a note or message from a sender that is intended to be read by a user whereas the front cover panel 113 of the user-assembled multi-substrate workpiece assembly 101c may be altered or worked-on by the cutting machine 130 in order to define the design 202 (e.g. a cut pattern) that is formed by the tool 19 of the cutting machine 130.

Components of the user-assembled multi-substrate workpiece assembly 101c (which may be alternatively referred to as a “card mat”) and methods of use thereof will be described in more detail below, but, in general, configurations of the user-assembled multi-substrate workpiece assembly 101c described herein reduce the space needed to alter or form a user-assembled multi-substrate workpiece assembly 101c by a factor of two. That is, the methods and apparatus for cutting the user-assembled multi-substrate workpiece assembly 101c in the present disclosure may not include the steps of laying a sheet of workpiece material in an unfolded orientation prior to cutting or inscribing a portion of that unfolded workpiece material (that would subsequently form a front cover panel of the unfolded workpiece material), and then subsequently folding the workpiece material to form a hinge such that the workpiece material resembled a card (defined by a front cover panel and a rear cover panel) after the workpiece material is altered or worked upon.

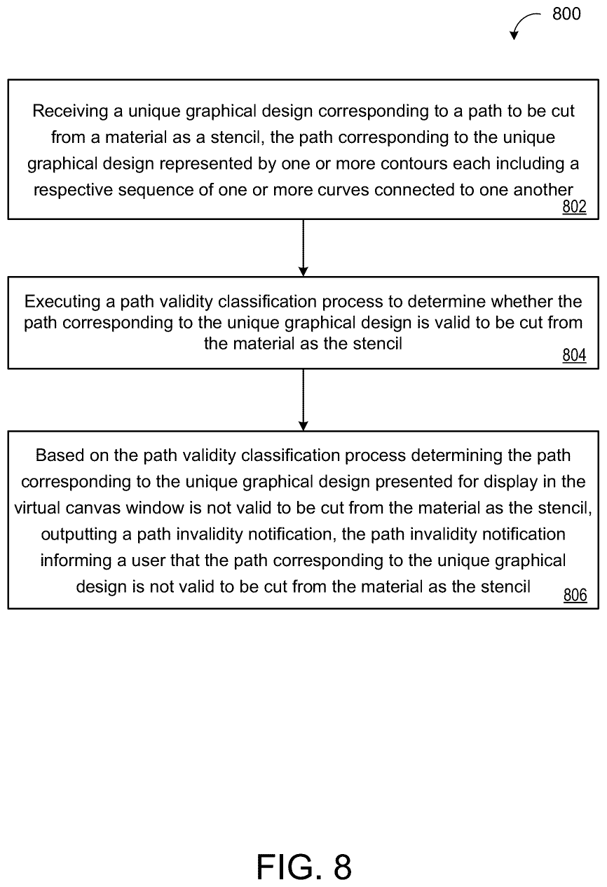

FIG. 8 is an example arrangement of operations for a method 800 of determining a path validity of a path 204 to be cut from material as a stencil 206. The path 204 may be represented by one or more contours 205 each including a respective sequence of one or more curves 207 connected to one another, that a path validity classification process 201 identifies and classifies as either valid or not valid. The method 800 includes a computer-implemented method that executes on data processing hardware 910 (FIG. 9) by performing the example arrangement of operations stored on memory hardware 920 (FIG. 9) in communication with the data processing hardware 910. The data processing hardware 910 may include the data processing hardware 112 of the user device 110, data processing hardware of the machine 130, and/or or data processing hardware of a remote system (not shown) in communication with the user device 110 and/or machine 130 via the network 120 or a direct connection. Similarly, the memory hardware 920 may include the memory hardware 114 of the user device 110, memory hardware of the machine 130, and/or memory hardware of the remote system.

At operation 802, the method 800 includes receiving a unique graphical design 202, the unique graphical design 202 corresponding to a path 204 to be cut from a material as a stencil 206. Here, the path 204 corresponding to the unique graphical design 202 is represented by one or more contours 205 each including a respective sequence of one or more curves 207 connected to one another.

At operation 804, the method 800 also includes executing a path validity classification process 201 to determine whether the path 204 corresponding to the unique graphical design 202 is valid to be cut from the material as the stencil 206. Based on the path validity classification process 201 determining the path 204 corresponding to the unique graphical design 202 is not valid to be cut from the material as the stencil 206, the method 800 also includes, at operation 806, outputting a path invalidity notification 216. Here, the path invalidity notification 216 informs a user 10 that the path 204 corresponding to the unique graphical design 202 is not valid to be cut from the material as the stencil 206.

FIG. 9 is a schematic view of an example computing device 900 that may be used to implement the systems (e.g., the designer 200) and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910 (e.g., data processing hardware), memory 920 (e.g., memory hardware), a storage device 930, a high-speed interface/controller 940 connecting to the memory 920 and high-speed expansion ports 950, and a low speed interface/controller 960 connecting to a low speed bus 970 and a storage device 930. Each of the components 910, 920, 930, 940, 950, and 960, are interconnected using various busses, and may be mounted on a common motherboard or in other manners as appropriate. The data processing hardware 910 and the memory hardware 920 may reside on the user device 110, a remote server (e.g., cloud computing environment), the cutting machine 130, or some combination thereof. The processor 910 can process instructions for execution within the computing device 900, including instructions stored in the memory 920 or on the storage device 930 to display graphical information for a graphical user interface (GUI) (e.g., the user interface 210) on an external input/output device (e.g., the user device 110), such as display 980 coupled to high speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high speed controller 940 manages bandwidth-intensive operations for the computing device 900, while the low speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers 900a, as a laptop computer 900b, as part of a rack server system 900c, as the cutting machine 130 (or other post-design processing machine), or as the user device 110.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user 10, one or more aspects of the disclosure can be implemented on a computer having a display device, e.g., a CRT (cathode ray tube), LCD (liquid crystal display) monitor, or touch screen (e.g., the screen 116 of the user device 110) for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Benefits, other advantages, and solutions to problems have been described herein with regard to specific implementations. However, the benefits, advantages, solutions to problems, and any elements that may cause any benefit, advantage, or solution to occur or become more pronounced are not to be construed as critical, required, or essential features or elements of the disclosure.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more implementations. One skilled in the relevant art will recognize that the subject matter of the present application may be practiced without one or more of the specific features or advantages of a particular embodiment. In other instances, additional features and advantages may be recognized in certain implementations that may not be present in all implementations of the disclosure. Further, in some instances, well-known structures, materials, or operations are not shown or described in detail to avoid obscuring aspects of the subject matter of the present disclosure. No claim element is intended to invoke 35 U.S.C. 112(f) unless the element is expressly recited using the phrase “means for.”

The scope of the disclosure is to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. Further, the term “plurality” can be defined as “at least two.” As used herein, the phrase “at least one of”, when used with a list of items, means different combinations of one or more of the listed items may be used and only one of the items in the list may be needed. The item may be a particular object, thing, or category. Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A, B, and C. In some cases, “at least one of item A, item B, and item C” may mean, for example, without limitation, two of item A, one of item B, and ten of item C; four of item B and seven of item C; or some other suitable combination.

All ranges and ratio limits disclosed herein may be combined. Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one or more implementations of the presented method. The steps recited in any of the method or process descriptions may be executed in any order and are not necessarily limited to the order presented. Furthermore, any reference to singular includes plural implementations, and any reference to more than one component or step may include a singular embodiment or step. Elements and steps in the figures are illustrated for simplicity and clarity and have not necessarily been rendered according to any particular sequence. Other steps and methods may be conceived that are equivalent in function, logic, or effect to one or more steps, or portions thereof, of the illustrated method.

Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Furthermore, no element, component, or method step in the present disclosure is intended to be dedicated to the public regardless of whether the element, component, or method step is explicitly recited in the claims.

The subject matter of the present disclosure may be embodied in other specific forms without departing from its spirit or essential characteristics. The described implementations are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A computer-implemented method executed on data processing hardware that causes the data processing hardware to perform operations comprising:
receiving a unique graphical design corresponding to a path to be cut from a material as a stencil, the path corresponding to the unique graphical design represented by one or more contours each comprising a respective sequence of one or more curves connected to one another;
executing a path validity classification process to determine whether the path corresponding to the unique graphical design is valid to be cut from the material as the stencil; and
based on the path validity classification process determining the path corresponding to the unique graphical design presented for display in the virtual canvas window is not valid to be cut from the material as the stencil, outputting a path invalidity notification, the path invalidity notification informing a user that the path corresponding to the unique graphical design is not valid to be cut from the material as the stencil.

2. The computer-implemented method of claim 1, wherein determining the path is not valid to be cut from the material as the stencil comprises identifying at least one curve in the respective sequence of one or more curves of at least one of the one or more contours representing the path that causes the path validity classification process to determine the path is not valid to be cut from the material as the stencil.

3. The computer-implemented method of claim 2, wherein the operations further comprise:
executing a design generating program to display on a screen in communication with the data processing hardware a graphical user interface having a virtual canvas window; and
presenting the unique graphical design for display in the virtual canvas window.

4. The computer-implemented method of claim 3, wherein:
outputting the path invalidity notification comprises causing the design generating program to output, for display on the screen, the path invalidity notification; and
the path invalidity notification displayed on the screen graphically augments the identified at least one curve presented for display in the virtual canvas window.

5. The computer-implemented method of claim 4, wherein the operations further comprise, after the design generating program outputs the path invalidity notification for display on the screen:
receiving, in the virtual canvas window, manipulation inputs from the user to create a modified path by adjusting one or more of the contours representing the path, the modified path presented for display in the virtual canvas window; and
re-executing the path validity classification process to determine if the modified path presented for display in the virtual canvas window is valid to be cut from the material as the stencil.

6. The computer-implemented method of claim 4, wherein the operations further comprise, after the design generating program outputs the path invalidity notification for display on the screen, modifying, without receiving any modification inputs in the virtual canvas window from the user, the path by adjusting one or more of the contours representing the path so that the modified path is valid to be cut from the material as the stencil.

7. The computer-implemented method of any of claim 6, wherein the operations further comprise, after outputting the path invalidity notification, generating, using the path corresponding to the unique graphical design that is determined to not be valid to be cut from the material as the stencil, a graphical representation for a virtual stencil cut from the material, the virtual stencil excluding portions of the material defined by any of the one or more contours that caused the path validity classification process to determine the path is not valid to be cut from the material as the stencil.

8. The computer-implemented method of claim 7, wherein, when the stencil comprises a negative stencil, the excluded portions of the material comprise any unsupported shapes of material that are defined by corresponding contours that are not boundary contours.

9. The computer-implemented method of claim 7, wherein, when the stencil comprises a positive stencil, each excluded portion of the material comprises an unsupported shape of material that is defined by a corresponding contour that:
is not a single contour defining a boundary of the path; and/or
is directly contained by a boundary contour.

10. The computer-implemented method of any of claim 9, wherein the operations further comprise receiving a user input indication indicating a command to instruct a machine in communication with the data processing hardware to create the stencil from the material by performing a cutting action on the material using the path corresponding to the unique graphical design that is determined to not be valid, the created stencil excluding the same portions of the material excluded by the virtual stencil.

11. The computer-implemented method of any of claim 10, wherein executing the path validity classification process to determine whether the path corresponding to the unique graphical design is valid to be cut from the material as the stencil comprises:
determining whether each of the one or more contours that represent the path corresponding to the unique graphical design define a closed shape;
for each corresponding contour of the one or more contours that represent the path corresponding to the unique graphical design, determining whether the corresponding contour intersects itself or another one of the one or more contours; and
determining the path corresponding to the unique graphical design is not valid to be cut from the material as the stencil based on determining that at least one of the one or more contours:
does not define a closed shape; or
intersects itself or another one of the one or more contours.

12. The computer-implemented method of claim 11, wherein, when each of the one or more contours that represent the path corresponding to the unique graphical design define the closed shape and each corresponding contour of the one or more contours does not intersect itself or another one of the one or more contours, executing the path validity classification process further comprises:
determining whether each of the one or more contours comprises a respective boundary contour;
determining whether the path comprises a boundary that is defined by a single contour of the one or more contours representing the path; and
for each corresponding contour of the one or more contours that does not comprise the respective boundary contour, determining whether the corresponding contour is directly contained by another one of the one or more contours that does comprise the respective boundary contour.

13. The computer-implemented method of claim 12, wherein:
the stencil comprises a negative stencil; and
determining the path corresponding to the unique graphical design is not valid to be cut from the material as the stencil comprises determining that the path is not valid to be cut from the material as the negative stencil based on determining that at least one contour of the one or more contours does not comprise the respective boundary contour.

14. The computer-implemented method of claim 13, wherein the operations further comprise determining the path corresponding to the unique graphical design is valid to be cut from the material as a positive stencil based on:
determining that the path comprises the boundary defined by the single contour of the one or more contours; and
determining that each of the one or more contours comprises the respective boundary contour or is directly contained by another one of the one or more contours that comprises the respective boundary contour.

15. The computer-implemented method of claim 12, wherein:
the stencil comprises a positive stencil; and
determining the path corresponding to the unique graphical design is not valid to be cut from the material as the stencil comprises determining that the path is not valid to be cut from the material as the positive stencil based on determining at least one of:
the path does not comprise the boundary defined by the single contour of the one or more contours; or
at least one of the one or more contours does not comprise the respective boundary contour or is not directly contained by another one of the one or more contours that comprises the respective boundary contour.

16. The computer-implemented method of claim 11, wherein the operations further comprise determining the path corresponding to the unique graphical design presented for display in the virtual canvas window is valid to be cut from the material as a negative stencil based on determining that each of the one or more contours comprises the respective boundary contour.

17. A system comprising:
data processing hardware; and
memory hardware in communication with the data processing hardware and storing instructions that when executed on the data processing hardware causes the data processing hardware to perform operations comprising:
receiving a unique graphical design corresponding to a path to be cut from a material as a stencil, the path corresponding to the unique graphical design represented by one or more contours each comprising a respective sequence of one or more curves connected to one another;
executing a path validity classification process to determine whether the path corresponding to the unique graphical design is valid to be cut from the material as the stencil; and
based on the path validity classification process determining the path corresponding to the unique graphical design presented for display in the virtual canvas window is not valid to be cut from the material as the stencil, outputting a path invalidity notification, the path invalidity notification informing a user that the path corresponding to the unique graphical design is not valid to be cut from the material as the stencil.

18. The system of claim 17, wherein determining the path is not valid to be cut from the material as the stencil comprises identifying at least one curve in the respective sequence of one or more curves of at least one of the one or more contours representing the path that causes the path validity classification process to determine the path is not valid to be cut from the material as the stencil.

19. The system of claim 18, wherein the operations further comprise:
executing a design generating program to display on a screen in communication with the data processing hardware a graphical user interface having a virtual canvas window; and
presenting the unique graphical design for display in the virtual canvas window.

20. The system of claim 19, wherein:
outputting the path invalidity notification comprises causing the design generating program to output, for display on the screen, the path invalidity notification; and
the path invalidity notification displayed on the screen graphically augments the identified at least one curve presented for display in the virtual canvas window.

21. The system of claim 20, wherein the operations further comprise, after the design generating program outputs the path invalidity notification for display on the screen:
receiving, in the virtual canvas window, manipulation inputs from the user to create a modified path by adjusting one or more of the contours representing the path, the modified path presented for display in the virtual canvas window; and
re-executing the path validity classification process to determine if the modified path presented for display in the virtual canvas window is valid to be cut from the material as the stencil.

22. The system of claim 20, wherein the operations further comprise, after the design generating program outputs the path invalidity notification for display on the screen, modifying, without receiving any modification inputs in the virtual canvas window from the user, the path by adjusting one or more of the contours representing the path so that the modified path is valid to be cut from the material as the stencil.

23. The system of claim 22, wherein the operations further comprise, after outputting the path invalidity notification, generating, using the path corresponding to the unique graphical design that is determined to not be valid to be cut from the material as the stencil, a graphical representation for a virtual stencil cut from the material, the virtual stencil excluding portions of the material defined by any of the one or more contours that caused the path validity classification process to determine the path is not valid to be cut from the material as the stencil.

24. The system of claim 23, wherein, when the stencil comprises a negative stencil, the excluded portions of the material comprise any unsupported shapes of material that are defined by corresponding contours that are not boundary contours.

25. The system of claim 23, wherein, when the stencil comprises a positive stencil, each excluded portion of the material comprises an unsupported shape of material that is defined by a corresponding contour that:
is not a single contour defining a boundary of the path; and/or
is directly contained by a boundary contour.

26. The system of claim 25, wherein the operations further comprise receiving a user input indication indicating a command to instruct a machine in communication with the data processing hardware to create the stencil from the material by performing a cutting action on the material using the path corresponding to the unique graphical design that is determined to not be valid, the created stencil excluding the same portions of the material excluded by the virtual stencil.

27. The system of claim 26, wherein executing the path validity classification process to determine whether the path corresponding to the unique graphical design is valid to be cut from the material as the stencil comprises:
determining whether each of the one or more contours that represent the path corresponding to the unique graphical design define a closed shape;
for each corresponding contour of the one or more contours that represent the path corresponding to the unique graphical design, determining whether the corresponding contour intersects itself or another one of the one or more contours; and
determining the path corresponding to the unique graphical design is not valid to be cut from the material as the stencil based on determining that at least one of the one or more contours:
does not define a closed shape; or
intersects itself or another one of the one or more contours.

28. The system of claim 27, wherein, when each of the one or more contours that represent the path corresponding to the unique graphical design define the closed shape and each corresponding contour of the one or more contours does not intersect itself or another one of the one or more contours, executing the path validity classification process further comprises:
determining whether each of the one or more contours comprises a respective boundary contour;
determining whether the path comprises a boundary that is defined by a single contour of the one or more contours representing the path; and
for each corresponding contour of the one or more contours that does not comprise the respective boundary contour, determining whether the corresponding contour is directly contained by another one of the one or more contours that does comprise the respective boundary contour.

29. The system of claim 28, wherein:
the stencil comprises a negative stencil; and
determining the path corresponding to the unique graphical design is not valid to be cut from the material as the stencil comprises determining that the path is not valid to be cut from the material as the negative stencil based on determining that at least one contour of the one or more contours does not comprise the respective boundary contour.

30. The system of claim 29, wherein the operations further comprise determining the path corresponding to the unique graphical design is valid to be cut from the material as a positive stencil based on:
determining that the path comprises the boundary defined by the single contour of the one or more contours; and
determining that each of the one or more contours comprises the respective boundary contour or is directly contained by another one of the one or more contours that comprises the respective boundary contour.

31. The system of claim 28, wherein:
the stencil comprises a positive stencil; and
determining the path corresponding to the unique graphical design is not valid to be cut from the material as the stencil comprises determining that the path is not valid to be cut from the material as the positive stencil based on determining at least one of:
the path does not comprise the boundary defined by the single contour of the one or more contours; or
at least one of the one or more contours does not comprise the respective boundary contour or is not directly contained by another one of the one or more contours that comprises the respective boundary contour.

32. The system of claim 27, wherein the operations further comprise determining the path corresponding to the unique graphical design presented for display in the virtual canvas window is valid to be cut from the material as a negative stencil based on determining that each of the one or more contours comprises the respective boundary contour.
